(19) United States
(12) Patent Application Publication
(10) Pub. No.: US 2011/0010283 A1
(43) Pub. Date: Jan. 13, 2011

(54) E-CARD

(76) Inventor: Eddie Williams, Temecula, CA (US)

Correspondence Address: Eddie Williams, 28983 Frankfort Lane, Temecula, CA, 92591, US

(21) Appl. No.: 12/782,037

(22) Filed: May 18, 2010

Related U.S. Application Data
(60) Provisional application No. 61/224,396, filed on Jul. 9, 2009.

(51) Int. Cl. G06F 3/048; G06Q 20/00; G06F 3/041

(52) U.S. Cl. 705/35; 715/810; 345/173

(57) ABSTRACT

A touch screen navigation device for making purchases includes a memory to store a first descriptor that identifies a card used in commerce; a scannable identifier adapted to provide a second descriptor to a scanner; a display for displaying changeable information including an icon for the card; and an input to select the card. When the card is selected, the display takes the appearance of the card, and when the scannable identifier is scanned, the scannable identifier provides the descriptor in the memory that identifies the card. A page bar may scroll between pages of icons. Interfaces may be included for E-apps, E-games, paying-bills, music and video, books, and text messaging.

### RELATED APPLICATIONS

The present application claims benefit of priority from U.S. Provisional Application No. 61/224,396, filed Jul. 9, 2009, which is incorporated herein by reference in its entirety.

### BACKGROUND OF THE INVENTION

The present invention generally relates to consumer purchasing tools, and more specifically, to an E-Card that includes a touch screen navigation device for making purchases.

Currently, consumers may have many credit cards in his or her wallet or purse with personal information displayed such as name, account number, etc. The cards are just plastic cards, with no ability for displaying changeable information to take the appearance of multiple cards used in commerce, such as credit or debit cards.

As can be seen, there is a need for a device to combine credit cards.

### SUMMARY OF THE INVENTION

In one aspect of the present invention, a device includes a memory to store a first descriptor that identifies a card used in commerce; a scannable identifier adapted to provide a second descriptor to a scanner; a display for displaying changeable information including an icon for the card; and an input to select the card; wherein, when the card is selected, the display takes the appearance of the card, and when the scannable identifier is scanned, the scannable identifier provides the descriptor in the memory that identifies the card.

In another aspect of the present invention, a device includes a memory to store a plurality of descriptors describing cards used in commerce; a scannable identifier adapted to provide a card descriptor to a scanner; and a display with a touch-sensitive control screen for displaying and selecting changeable information, the changeable information including icons for the cards; wherein, when an icon for a card is selected, the display takes the appearance of the card, and when the scannable identifier is scanned, the scannable identifier provides the descriptor in the memory that identifies the selected card.

These and other features, aspects and advantages of the present invention will become better understood with reference to the following drawings, description and claims.

### BRIEF DESCRIPTION OF THE DRAWINGS

FIG. 1 depicts an embodiment of the present invention displaying a greeting;

FIG. 2 depicts the embodiment of FIG. 1 displaying a balance;

FIG. 3 depicts the embodiment of FIG. 1 entering a code;

FIG. 4 depicts the embodiment of FIG. 1 displaying a menu;

FIG. 5 depicts the embodiment of FIG. 1 displaying a further menu;

FIG. 6 depicts the embodiment of FIG. 1 displaying a website;

FIG. 7 depicts the embodiment of FIG. 1 for E-Apps;

FIG. 8 depicts the embodiment of FIG. 1 for E-games;

FIG. 9 depicts the embodiment of FIG. 1 for paying bills;

FIG. 10 depicts the embodiment of FIG. 1 for music and video;

FIG. 11 depicts the embodiment of FIG. 1 for books; and

FIG. 12 depicts the embodiment of FIG. 1 for text messaging.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a wireless touch screen navigation device for purchasing items.

An embodiment of the present invention relates to a card that lets a user consolidate and download up to 30 credit cards into one card.

This wireless device may check balances from savings and checking accounts, keep track of all spending with its track spending feature, update expired credit cards and make purchases from any one of the cards that is downloaded into the E-card and stored in a memory. An E-Card may look like a credit card with a similar shape and size, while being a wireless system with a database and software. Embodiments may be used to store additional personal info, to play music and read books. Embodiments may be used in the medical field for storing personal medical information for the consumer. An embodiment may provide continued and efficient service at local markets, fuel stations, and ATM machines, or wherever an E-Icon is advertised. Embodiments may contain, for example, up to nine pages of information on the card.

In an embodiment, customers may navigate through a touch sensitive control screen, after downloading credit card account numbers to the E-card. One may touch the icon of the credit card that is to be charged. When touching the icon, the entire card may appear to become that icon. To use the card, one passes the E-icon located on the card over the E-icon where it is located on the ATM machine, fuel station, or market. When the two E-icons meet or are passed over each other, they become engaged and activate the E-card. The customer may have charged or purchased his or her product to a specific and particular card, for which description data may be download into the E-card.

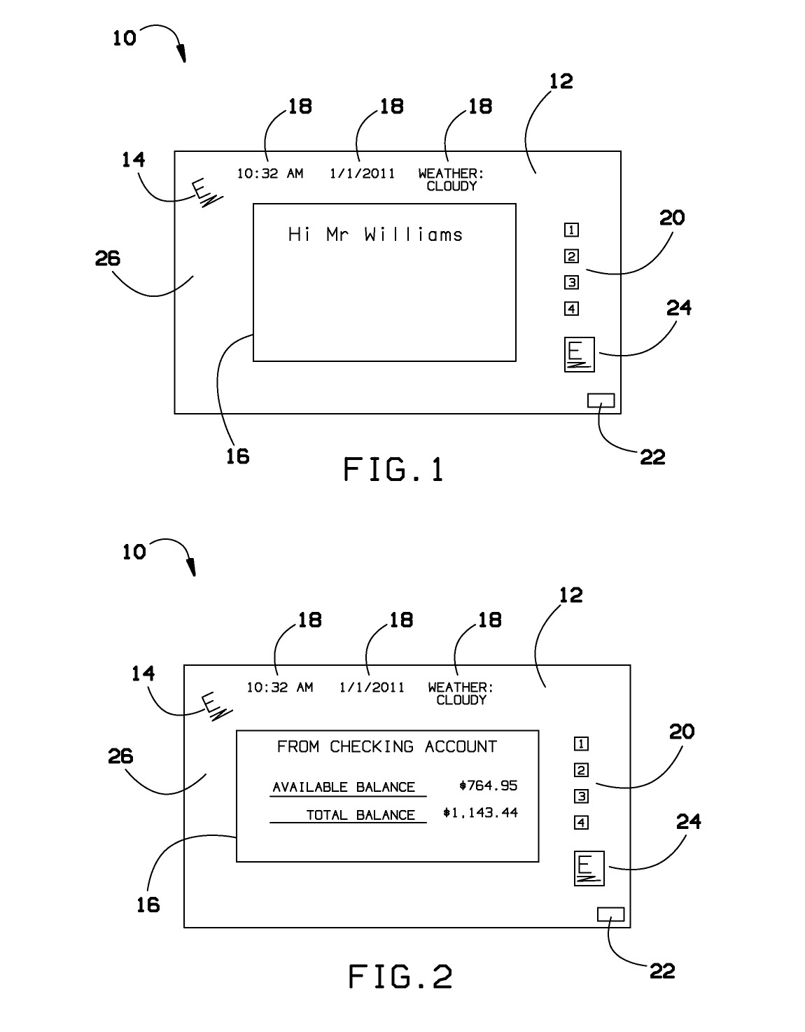

As depicted in FIG. 1, an embodiment of an E-card 10 may include a touch-sensitive control screen 12 having an E-Icon 14 and a main display 16. The E-Icon 14 may be a symbol or other identifier readable by card scanner, such as a bar code, magnetic strip, or holographic element. The main display 16 may be a partial area of the E-Card or the entire E-Card. The main display 16 may displays changeable information to the user, which may take the appearance of a card such as a credit card or other card used in commerce. An embodiment may have additional display areas 18 for time, date, and weather. An embodiment may have areas that act as touch-sensitive inputs, which may include a page bar 20 to scroll, a power button 22, and website icon 24 that may link to an E-Icons website. Unused areas may have a background wall paper 26. In various embodiments, the display or input elements are on the front or the back of the card.

As depicted in FIG. 1, the user may turn the card on, and then see a personal greeting, which may be set to use a first or last name.

As depicted in FIG. 2, a user may check an account balance. When the user touches the E-card, the checking account balance may be checked and displayed. The E-card may give the user an account balance from savings or checking accounts in the main display 16.

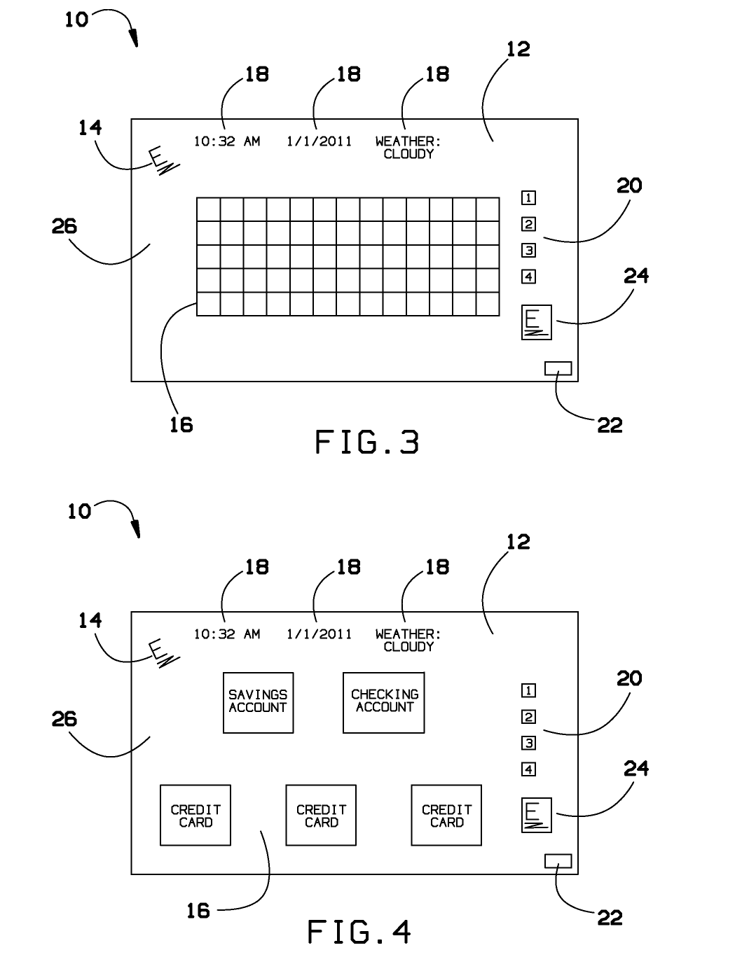

As depicted in FIG. 3, a user may use a simulated keyboard to put in a code to access the E-card. After the greeting, the user may see a “Put in security code” page or display. The user may access the card's savings, checking, or other information using the security code.

As depicted in FIG. 4, the first page may display various icons or other descriptors for cards used in commerce, with for example, five icons. To use the card, a user may touch the checking icon to make a purchase or to get money from that account. One may use the same method for ATM machines, fuel stations, or markets.

As depicted in FIG. 5, upon touching the checking icon, the E-card may appear to become a checking account terminal. After touching the icon of the user's choice, the card may appear to become that card, and become ready to be used for purchases or charges.

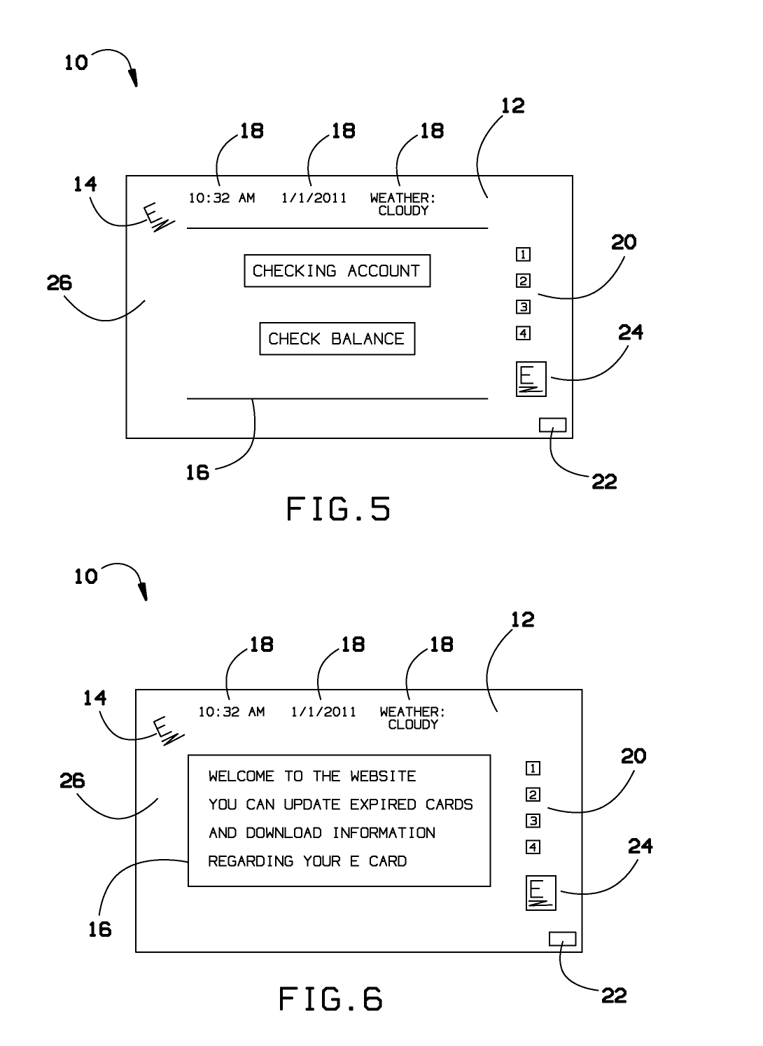

As depicted in FIG. 6, to access a website, a user may touch a website icon 24 that may link to an E-Icons website. The user may touch the icon located under the page bar 20, and go directly to the website for updates on expired credit cards and downloads.

As depicted in FIGS. 1-6, an embodiment of an E-Card may support touch-screen navigation. To navigate through page-to-page, one may touch the page bar 20 to scroll and search for a specific card to use. Each page may have, for example, 5 icons per page. One may touch the page bar button number 2, and the user will be able to use 5 more credit cards of his or her choosing that have been downloaded into the E-card.

To use an embodiment of an E-card, one could use the E-card to make a purchase by touching an icon on the touch-sensitive control screen 12. After the card has become engaged, either a portion of the E-card or the entire E-card appears to become the selected card, which could be a card used in commerce such as a credit card or debit card. One may then pass the E-Icon 14 portion of the card over a scanner identified by similar icon located in the designated area of the ATM machine, fuel station, market, or other sales interface that has the appropriate logo. The E-card will automatically charge that purchase to the user's account.

Embodiments may include interfaces for features such as apps (programmed applications), games, paying-bills, music and video, books, and text messaging.

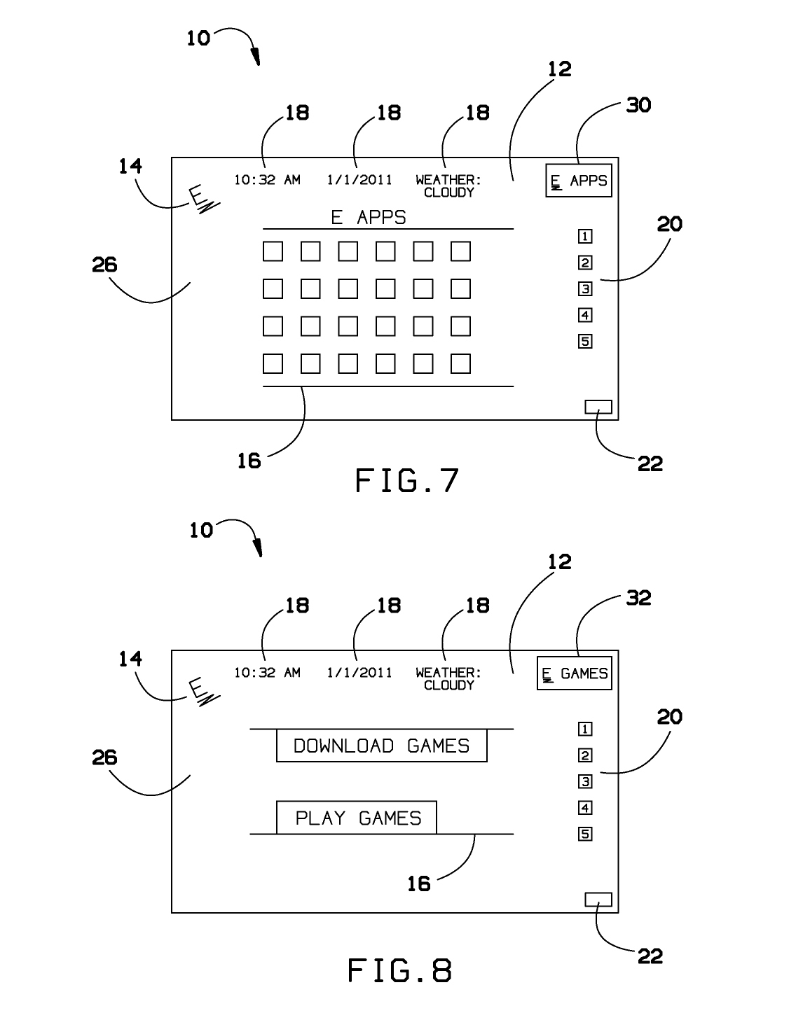

As depicted in FIG. 7, an embodiment may have an E-Apps store that lets the user enjoy apps. The user may touch an E-Apps icon 30 and the E-card may display a list of E-Apps. The app of the user's choice may be enjoyed by touching that icon so that it will be ready for use.

As depicted in FIG. 8, an embodiment may have an E-Games icon 32 for a feature to download and play video games. A user may go to the E website or another site that lets on download and play games.

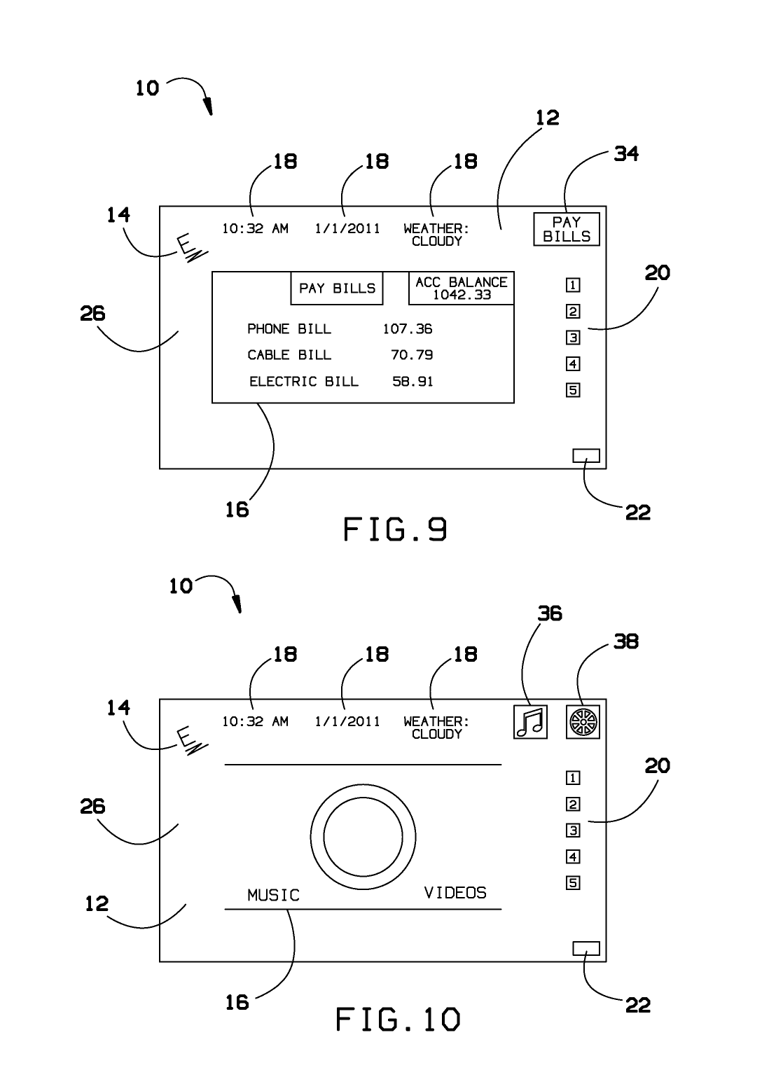

As depicted in FIG. 9, an embodiment may have a pay bills icon 34 for a feature to pay bills. This feature may allow the user to pay bills from the E-Card. After the user registers the accounts, when the user wants to pay with the E-card, the user may pay the bill from this card with a time and date stamp.

As depicted in FIG. 10, an embodiment may have a music icon 36 and a video icon 38. These icons may let the user download and play music and videos.

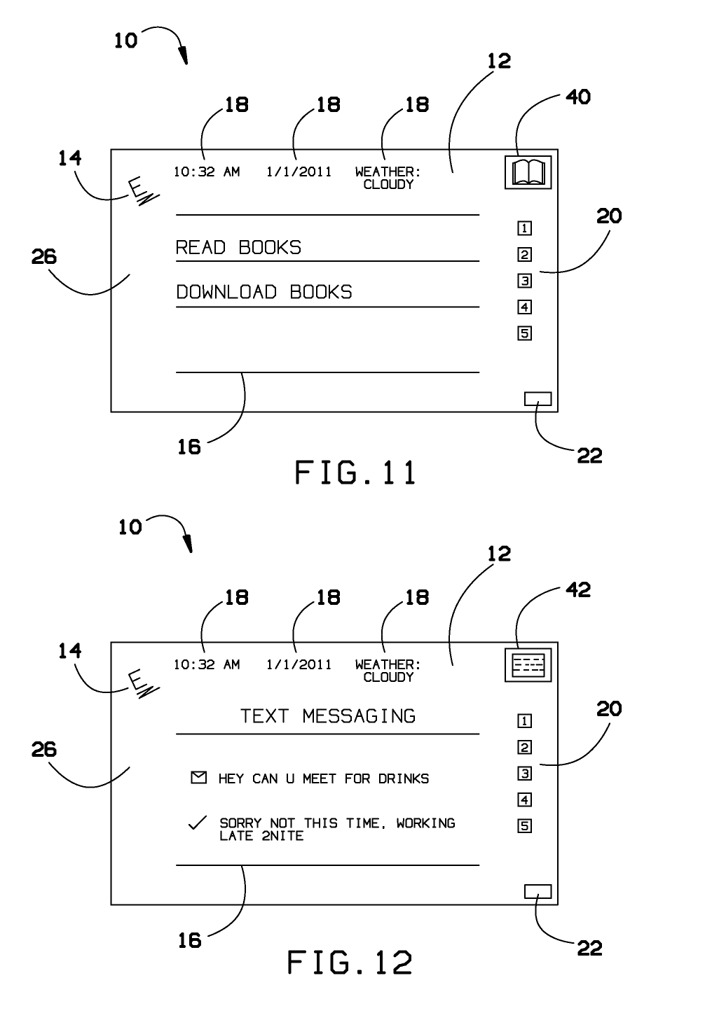

As depicted in FIG. 11, an embodiment may have a book icon 40. When the user touches the book icon 40, the card may become like a book and gives the user the option of downloading and reading a book. The use may download from the E-website or from the user's favorite store. The E-Card may have enough memory to store several books.

As depicted in FIG. 12, an embodiment may have a text icon 42. The use may go to the text icon 42 for sending and receiving text messages.

An embodiment of a method for using an E-card may including the following steps, performed by a user. One may put in the battery and turn on power. One may put in the name, date, time, PIN, etc. After each data entry, one may press a SET button. One may set the security feature, using a name or number code, set the background wall paper, and set cards on the first page. One may choose a credit card company from a list, and click on the card, and put in the credit card account number for the card, and also the 3-digit number on the back, and the expiration date. One may repeat this process again for up to 5 cards per page.

In an embodiment, the user may further set the icon size for the card, and the E-Icon will automatically appear on the E-card. This may give the customer access to the E-card's website. After all the information has been logged in, the user presses ENTER. The information may then be downloaded into the E-card.

To use an embodiment of a wireless E-card, a user may turn on the card, and enter the security code or number. A small presentation may appear and say, for example, “Hello Mr. Williams, have a nice day!” across the screen. The first page may appear with 5 icons across the middle of the card and the E-Icon may appear, for example, in the upper left or right. One may touch any one of the icons on the page and the card appears to become that card. One may check savings account balance or checking account balances. Touch an icon for checking, then touch for check balance, and then the card may give the current balance. Repeat the same process for savings. Using a card at the ATM, one may touch the screen for a selected account to receive money. Pass the E-Icon on the card over a similar E-Icon on the ATM machine, then put in the PIN number code and how much money that the user wishes to receive, then receive the cash. Using an E-card at a fuel station, the user may touch an icon on the card to select from where he or she wants to charge, credit card, savings, or checking, and then pass the E-Icon located on the card of the E-Icon at the register to pay for the goods.

In an embodiment, the E-card website may be website that may contain downloads and updates for expired credit cards. The E-card may have a feature that tracks specific spending, so one can track kid's allowances, how much is spent on fuel, how much spent on groceries, etc. After using any of the card's icons, the user may touch the screen again to minimize the icon. The, choose another icon to use or simply navigate through to other pages. The E-card may include security feature, such as a personal security PIN number or word code that only the user has access to. The E-card may be thin, and shaped like a standard credit card but larger to accommodate the inputs.

It should be understood, of course, that the foregoing relates to exemplary embodiments of the invention and that modifications may be made without departing from the spirit and scope of the invention as set forth in the following claims.

We claim:

1. A device comprising:
a memory to store a first descriptor that identifies a card used in commerce;
a scannable identifier adapted to provide a second descriptor to a scanner;
a display for displaying changeable information including an icon for the card; and
an input to select the card;
wherein, when the card is selected, the display takes the appearance of the selected card, and when the scannable identifier is scanned, the second descriptor provided by the scannable identifier includes the first descriptor.

2. The device of claim 1, further comprising:
a touch-sensitive control screen.

3. The device of claim 1, wherein the display includes a touch-sensitive control screen and the input to select the card is an area of the screen that corresponds to the icon for the card.

5. The device of claim 1, wherein the memory stores a plurality of descriptors that include icons depicting cards used in commerce, and the changeable information includes descriptors for each of the plurality of cards.

6. The device of claim 1, further comprising:
a page bar to select a page of cards;
wherein the changeable information includes one or more descriptors for the selected page of cards.

7. The device of claim 1, further comprising:
a wireless interface;
wherein the changeable information includes information retrieved utilizing the wireless interface.

8. A device comprising:
a memory to store a plurality of descriptors describing cards used in commerce;
a scannable identifier adapted to provide a card descriptor to a scanner; and
a display with a touch-sensitive control screen for displaying and selecting changeable information, the changeable information including icons for the cards;
wherein, when an icon for a card is selected, the display takes the appearance of the card, and when the scannable identifier is scanned, the scannable identifier provides the descriptor in the memory that identifies the selected card.

9. The device of claim 8, further comprising:
a page bar to select a page of cards;
wherein the changeable information includes icons for the selected page of cards.

10. The device of claim 8, further comprising:
an apps interface;
a games interface;
a paying-bills interface;
a music and video interface;
a books interface; and
a text messaging interface.
